(19) United States
(12) Patent Application Publication
(10) Pub. No.: US 2007/0230466 A1
(43) Pub. Date: Oct. 4, 2007

(54) Broadcast receiving apparatus and broadcast receiving method

(75) Inventor: Kazuhiko Muguruma, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/717,047

(22) Filed: Mar. 13, 2007

(30) Foreign Application Priority Data
Mar. 31, 2006 (JP) 2006-100780

(51) Int. Cl. H04L 12/56

(52) U.S. Cl. 370/390

(57) ABSTRACT

According to one embodiment, there is provided a broadcast receiving apparatus including an IP communication section which acquires, via a network, standard time information, time correction information obtained by delaying a broadcast signal of a specific broadcast channel by IP retransmission, and stream information, a time management section which obtains a broadcast time of the specific broadcast channel, based on the standard time information and the time correction information from the IP communication section, and a reservation management section which stores reservation information on a program of the specific broadcast channel, and then, in response to the broadcast time of the time management section, carries out reserved image recording of stream information acquired by the IP communication section responsive to the reservation information.

### CROSS-REFERENCE TO RELATED APPLICATIONS

This application is based upon and claims the benefit of priority from Japanese Patent Application No. 2006-100780, filed Mar. 31, 2006, the entire contents of which are incorporated herein by reference.

### BACKGROUND

1. Field

The present invention relates to a broadcast receiving apparatus and a broadcast receiving method for receiving IP retransmission using an IP communication network for digital broadcast, and particularly to a broadcast receiving apparatus and a broadcast receiving method for calculating time information for each broadcast channel.

2. Description of the Related Art

Recently, it has been known that a TV channel broadcast may be stream-distributed via a network such as the Internet, for example, in addition to broadcast receiving from general electromagnetic waves. In this case, a delay of broadcast time information may cause a problem.

In Patent Document 1 (Jpn. Pat. Appln. KOKAI Publication No. 2005-303799), there is disclosed a digital broadcast receiver having means for calculating and holding a difference between an incorporated clock and time information included in a received broadcast signal, wherein reservation setting means is implemented by correcting this difference.

However, in the conventional technique of Patent Document 1, there is a problem that measurement as to how much a broadcast signal is delayed from a standard time must be made inside a digital broadcast receiver per se, and a precise value cannot be obtained immediately.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an example of a configuration of an IP retransmission system according to an embodiment of the present invention;

FIG. 2 is a block diagram depicting an example of a configuration of a broadcast receiving apparatus for receiving IP retransmission service according to an embodiment of the present invention;

FIG. 3 is a block diagram depicting an example of a detailed configuration of a broadcast receiving apparatus for receiving IP retransmission service according to an embodiment of the present invention;

FIG. 4 is a timing chart showing an example of a standard time T, a broadcast time T1, and a stream time T2 in a broadcast receiving apparatus according to an embodiment of the present invention;

FIG. 5 is a flow chart showing an example of a processing operation of obtaining a broadcast time T1 from a standard time T and a correction value T_{A} in a broadcast receiving apparatus according to an embodiment of the present invention;

FIG. 6 is a timing chart showing an example of a processing operation of obtaining a correction time T3 from a stream time T2 and a correction value T_{A} in a broadcast receiving apparatus according to an embodiment of the present invention; and

FIG. 7 is a flow chart showing an example of a processing operation of obtaining a correction time T3 from a stream time T2 and a correction value T_{A} in a broadcast receiving apparatus according to an embodiment of the present invention.

### DETAILED DESCRIPTION

Various embodiments according to the invention will be described hereinafter with reference to the accompanying drawings. In general, according to one embodiment of the invention, a broadcast receiving apparatus, comprising: an IP communication section which acquires, via a network, standard time information, time correction information obtained by delaying a broadcast signal of a specific broadcast channel by IP retransmission, and stream information; a time management section which obtains a broadcast time of the specific broadcast channel, based on the standard time information and the time correction information from the IP communication section; and a reservation management section which stores reservation information on a program of the specific broadcast channel, and then, in response to the broadcast time of the time management section, carries out reserved image recording of stream information acquired by the IP communication section responsive to the reservation information.

An embodiment of the present invention provides a broadcast receiving apparatus and a broadcast receiving method capable of carrying out reliable reserved image recording processing operation of a stream signal or the like by utilizing externally supplied correction (delay) time with respect to a standard time of an IP stream signal.

One embodiment of the present invention is a broadcast receiving apparatus, comprising: an IP communication section which acquires, via a network, standard time information, time correction information obtained by delaying a broadcast signal of a specific broadcast channel by IP retransmission, and stream information; a time management section which obtains a broadcast time of the specific broadcast channel, based on the standard time information and the time correction information from the IP communication section; and a reservation management section which stores reservation information on a program of the specific broadcast channel, and then, in response to the broadcast time of the time management section, carries out reserved image recording of stream information acquired by the IP communication section responsive to the reservation information.

In this manner, time correction information considering a delay of a stream signal to be IP-retransmitted is supplied externally over a network, thereby stably and reliably enabling a stream signal reservation/image recording operation or the like without a complicated work of measuring a delay time of a stream signal by oneself.

Now, embodiments of the present invention will be described in detail with reference to the accompanying drawings.

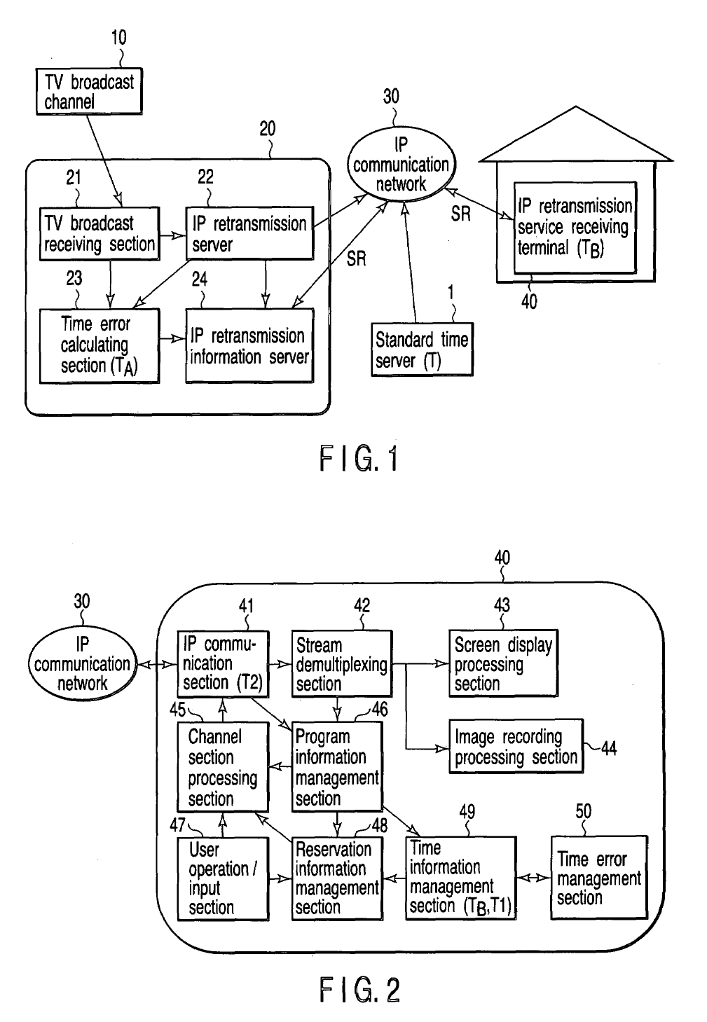

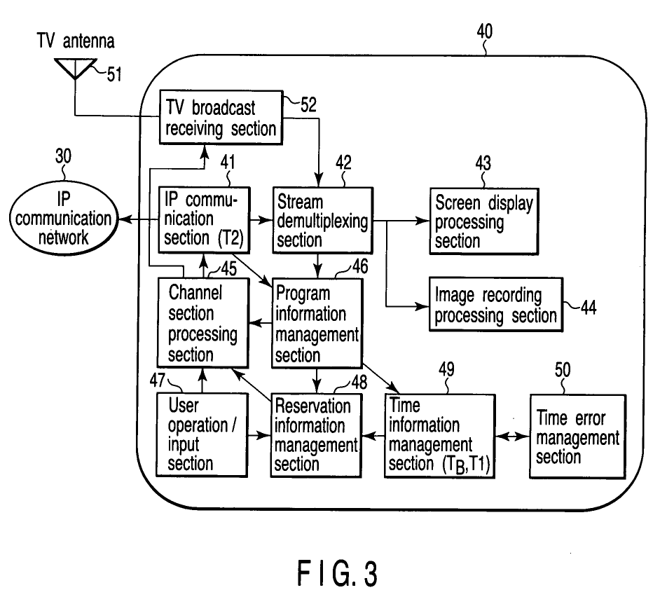

FIG. 1 is a block diagram depicting an example of a configuration of an IP retransmission system according to an embodiment of the present invention. FIG. 2 is a block diagram depicting an example of a configuration of a broadcast receiving apparatus for receiving IP retransmission service according to an embodiment of the present invention. FIG. 3 is a block diagram depicting an example of a detailed configuration of a broadcast receiving apparatus for receiving IP retransmission service according to an embodiment of the present invention, similarly.

<Example of Digital Broadcast Receiver According to the Present Invention>

(Configuration of IP Retransmission System of TV Broadcast Channel>

First, an example of an IP retransmission system of a TV broadcast will be described in detail with reference to FIG. 1. The IP retransmission system of TV broadcast has: a TV broadcast channel 10 and retransmission servers 20 connected thereto; an IP communication network 30 and a standard time server 1 connected thereto; an IP playback signal service receiving terminal 40 and the like. Here, it is preferable that the IP playback signal service receiving terminal 40 or the like should be digital equipment having an image recording function such as a digital television or a hard disk recorder or should be a multi-functional personal computer (PC).

(Broadcast Receiving Apparatus Having IP Retransmission Service Function)

Now, an exemplary configuration of a broadcast receiving apparatus included in an IP retransmission system will be described with reference to FIGS. 2 and 3. A broadcast receiving apparatus 40 has: an IP communication section 41 connected to an IP communication network 30; a stream demultiplexing section 42 connected to the IP communication section 41; a screen display processing section 43 supplied with a video image stream from the stream demultiplexing section 42; and an image recording processing section 44.

Further, the broadcast receiving apparatus 40 has: a program information management section 46 connected to the IP communication section 41 and managing selectable channel information; a channel selection processing section 45 connected to the program information management section 46; a reservation information management section 48 for carrying out image recording reservation; a time information management section 49; a time error management section 50 connected to the time information management section 49; and a user operation/input section 47 connected to the channel selection processing section 45 and the reservation information management section 48.

The time error management section 50 stores, as time correction data, a time obtained by adding a delay time generated by a stream receiving processing operation at the receiving terminal 40 to error information obtained from the IP retransmission information server 24. In addition, the time information management section 49 acquires a standard time T via the IP communication network 30 from a standard time server 1 that supports NTP, and then, sets the acquired standard time as a system time.

Furthermore, as shown in FIG. 3, the broadcast receiving apparatus 40 according to an embodiment of the present invention further has a TV broadcast receiving section 52 connected to a TV antenna 51, and an output signal thereof is supplied to the stream demultiplexing section 42.

The stream demultiplexing section 42 demultiplexes a desired signal on a TV screen from an inputted TV broadcast signal stream, and then, supplies the demultiplexed signal to the screen display processing section 43. At the same time, this demultiplexing section demultiplexes associated information such as program information from the TV broadcast signal stream, and then, stores the demultiplexed information in the program information management section 46. Using the stored program information, a program chart can be displayed, making it possible to specify a program from a program chart screen, and then, set image recording reservation.

When an image recording reservation instruction is inputted from the user operation/input section 47 in accordance with a program chart or by specifying date and time, reservation information is supplied to the reservation information management section 48. The reservation information management section 48 acquires time correction information on a reservation specified channel from the time error management section 50, corrects the inputted image recording operation time, and then, stores the corrected operation time as a reservation execution time.

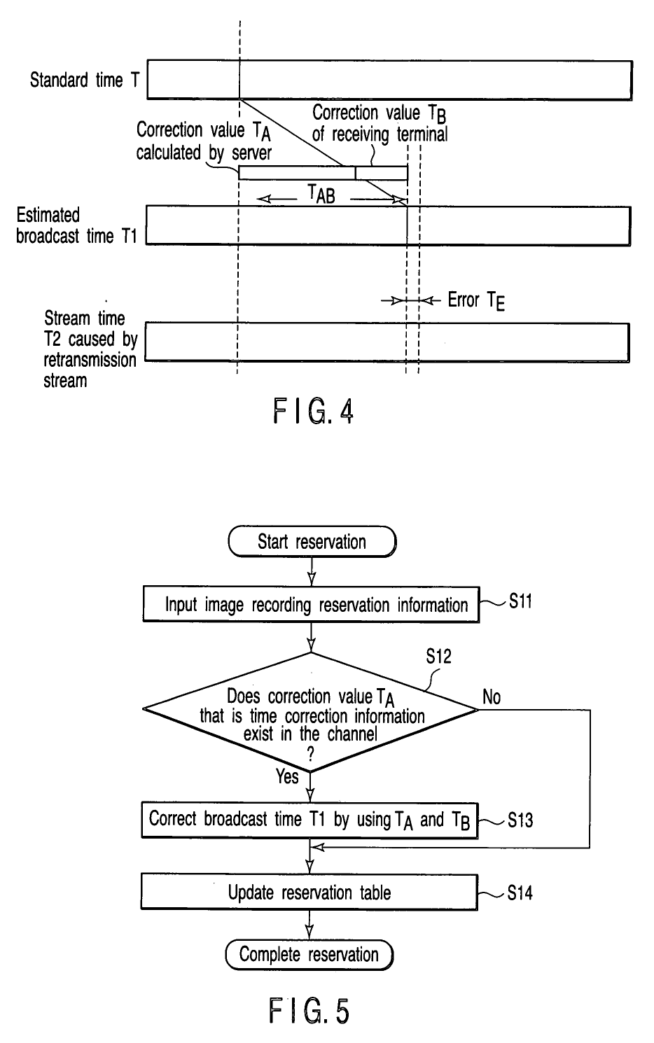

To the broadcast receiving apparatus 40 having such a configuration, a video image signal assigned from the retransmission servers 20, which has been assigned from the TV broadcast channel 10, is supplied as an IP stream signal via the IP communication network 30. The IP stream signals are demultiplexed in the stream demultiplexing section 42 via the IP communication section 41, and the demultiplexed signals are supplied to the screen display processing section 43 and the image recording processing section 44, respectively. Then, a video image and a voice corresponding to the IP stream signal are reproduced via a display section or a speaker section, although not shown.

<Method for Calculating Broadcast Time: FIGS. 4 and 5>

FIG. 4 is a timing chart showing an example of a standard time T, a broadcast time T1, and a stream time T2 in the broadcast receiving apparatus. FIG. 5 is a flow chart showing an example of a processing operation of obtaining a correction time T1 from a standard time T and a correction value T_{A} in the broadcast receiving apparatus.

—Delay Time Failure

In the broadcast receiving apparatus 40 having such a function, broadcast programs received via a TV antenna and broadcast programs assigned and reproduced via an IP communication network are different in delay time even their contents are identical to each other. Therefore, in the case where reserved image recording, for example, is merely managed in accordance with a system time incorporated in the broadcast receiving apparatus 40, recording a program based on an IP stream signal may cause a delay of several seconds.

Here, some examples of delay times different depending on communication modes are shown. What is transmitted with the least delay is an analog TV broadcast transmitted by electromagnetic waves, and it is possible to say that a delay time is within one second. What is transmitted with the second least delay is a digital TV broadcast transmitted by electromagnetic waves, and it is possible to say that a delay time is between 1 second to 2 seconds. Further, in the case of the IP retransmission service using an IP stream signal via the IP communication network 30 or the like, a delay of several seconds or more may be observed.

In the case where reserved image recording is made using a hard disk recorder or the like, for example, a change of a delay time according to such a communication mode causes a deviation from a program start time and an end time, denotes a faulty image recording state, and requires improvement. Therefore, acquiring time information for each broadcast channel is a key to achieving precise image recording reservation processing operation.

—Method for Calculating Broadcast Time T1

Referring now to the graph of FIG. 4 and the flowchart of FIG. 5, a description will be given with respect to a process for obtaining a broadcast time T1 of a channel of a certain IP stream in accordance with a standard time T defined by NTP (Network Time Protocol) and a correction time T_{A} defined by the retransmission servers 20.

In the broadcast receiving apparatus 40, first, image recording/reservation information is inputted via the user operation/input section 47 or the like. Then, the time information management section 49 of FIGS. 2 and 3 judges whether or not a correction value T_{A} that is time correction information exists in this channel. The correction value T_{A} that is time correction information responsive to a channel is generated by means of the time error calculating section 23 of the retransmission servers 20 of FIG. 1. If there exists the correction value T_{A} that is time correction information responsive to the channel, as shown in FIG. 4, the correction value T_{A} and a correction value T_{B} obtained at the broadcast receiving apparatus 40 are combined with the standard time T, and then, an estimated broadcast time T1 is corrected (S13). Then, a reservation table for image recording reservation of the reservation information management section 48 of FIGS. 2 and 3, responsive to this broadcast time T1, is updated (step S14). In this manner, a precise, stable image recording/reservation processing operation is enabled irrespective of a communication mode.

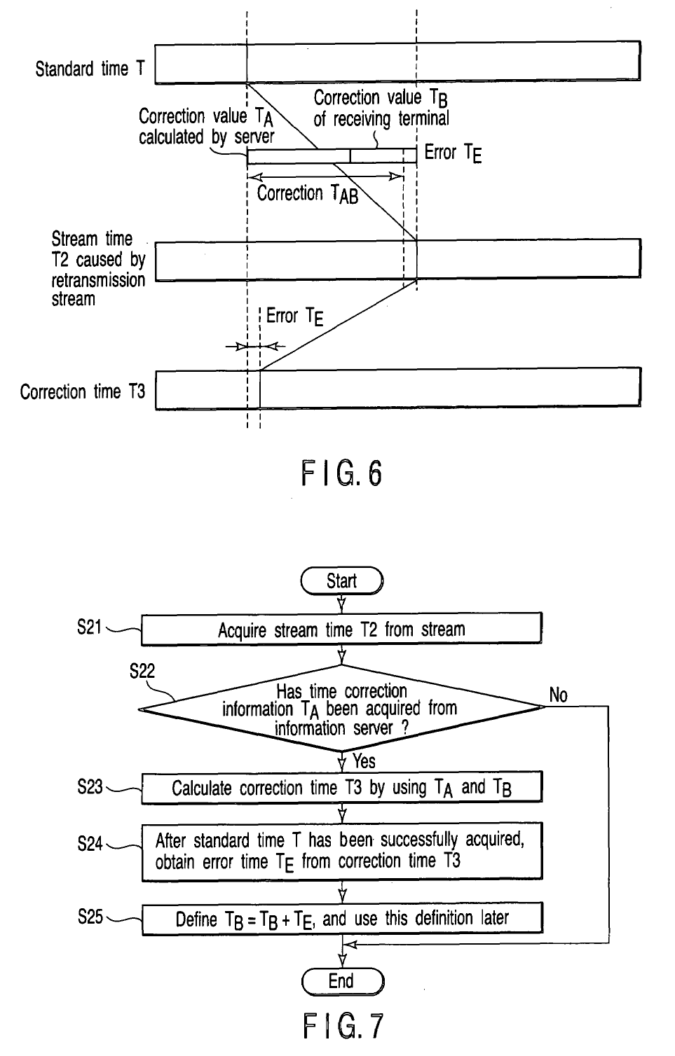

The error value T_{E} is a value that cannot be estimated by these theoretical values, and a stream time T2 of a final redistribution stream signal SR has an error by the broadcast time T1 and the error value T_{E}. However, as long as the error value T_{E} is stable, it becomes possible to predict a very precise value including the error value T_{E} from a next time, as described later.

<Method of calculating standard time T: FIGS. 6 and 7>

Now, referring to the timing chart of FIG. 6 and the flowchart of FIG. 7, a description will be given with respect to a method for estimating a standard time T based on a stream time T2, a correction value T_{A}, and a correction value T_{B} in a case in which a standard time T defined in accordance with NTP (Network Time Protocol) over the IP communication network 30 cannot be detected.

First, the time information management section 49 acquires a stream time T2 from a stream acquired from the IP communication section 41 (step S21). Next, when time correction information T_{A} is acquired from the retransmission servers 20 (step S22), as shown in FIG. 6, the correction value T_{A} and the correction value T_{B} are subtracted from the stream time T2, thereby calculating a correction time T3 (step S23). In this manner, the correction value T3 can be obtained as a value almost close to the standard time T (step S24).

Using this correction time T3, for example, it becomes possible to display a time on a television screen or use a start timing obtained at the time of a reservation operation of another broadcast system.

Then, the error value T_{E} is obtained by acquiring an actual standard time T and a correction value T_{B} of a receiving terminal reflecting a precise value T_{E} is obtained, thereby making it possible to estimate an error-free standard time T (step S25).

While an example of a simple adding computation has been shown in the step S25, another control computation having a time constant, for example, may be carried out.

According to the above description, a time lag between a time set at the time of image recording reservation and a time of a received TV broadcast signal stream is corrected, making it possible to record a user's desired program without any excess or insufficiency.

### OTHER EMBODIMENTS

In the embodiment described above, time error information supplied by the IP retransmission information server 24 has been defined as only an error between a standard time and a time of one TV broadcast signal (broadcast channel). However, a typical value such as an average of delay times in an IP communication network relating to a plurality of broadcast channels is used as time error information, thereby enabling correction with high precision over a plurality of broadcast channels without adhering to such one broadcast channel.

As long as an image recording end time follows time information acquired from a received TV broadcast stream, even if an error occurs in a correction time, the end time can be precisely operated.

While the foregoing embodiments have described a case of measuring a delay time at the time of execution by a server and a receiving terminal, respectively, a value measured in advance, a desktop calculation value and the like may be used.

While the foregoing embodiments have shown an example of providing time error information on a channel by channel basis, in the case where a difference in time error all over the services is small, a typical value of the whole services may be provided.

While the foregoing embodiments have handled only time error information when a TV signal stream is TP-retransmitted, time error information on a general digital broadcast is also provided via an information server, thereby making it possible to correct time information with respect to such a general digital broadcast.

The time error information provided by the server may be provided as an error from time information that can be acquired from a TV broadcast instead of an error from a standard time. However, the correction time that can be corrected by a receiving terminal in that case is identical to time information that can be obtained when the receiving terminal has directly received a general TV broadcast. The receiving terminal can correct a standard time to a time included in a received TV broadcast signal by simple means and can switch a signal at a timing without any excess or insufficiency at the time of a reservation operation.

While the present invention can be achieved by one skilled in the art in accordance with a variety of embodiments described above, further, it is obvious for one skilled in the art to conceive a variety of modifications of these embodiments and to apply to a variety of embodiments even if one skilled in the art does not have inventive ability. Therefore, the present invention encompasses a broad range without deviating from a disclosed principle and novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving apparatus, comprising:
an IP communication section which acquires, via a network, standard time information, time correction information obtained by delaying a broadcast signal of a specific broadcast channel by IP retransmission, and stream information;
a time management section which obtains a broadcast time of the specific broadcast channel, based on the standard time information and the time correction information from the IP communication section; and
a reservation management section which stores reservation information on a program of the specific broadcast channel, and then, in response to the broadcast time of the time management section, carries out reserved image recording of stream information acquired by the IP communication section responsive to the reservation information.

2. The broadcast receiving apparatus according to claim 1, wherein the time correction information also includes an internal error caused by an internal processing operation of the broadcast receiving apparatus.

3. The broadcast receiving apparatus according to claim 1, wherein the standard time acquired by the IP communication section is time information provided by NTP (Network Time Protocol).

4. A broadcast receiving apparatus, comprising:
an IP communication section which acquires, via a network, stream information and time correction information obtained by delaying a broadcast signal of a specific broadcast channel by IP retransmission;
a time management section which calculates a standard time, based on stream time information included in the stream information from the IP communication section and the time correction information; and
a processing section which, based on the standard time information calculated by the time management section, carries out processing so as to use the calculated time information for a screen display of time or for a timing of a reservation operation of other than the specific broadcast channel.

5. The broadcast receiving apparatus according to claim 4, wherein the time correction information also includes an internal error caused by an internal processing operation of the broadcast receiving apparatus.

6. The broadcast receiving apparatus according to claim 1 or 4, wherein the time correction information is a value obtained by predetermined computation of delays, in a plurality of channels, generated by IP retransmission without being limited to the one broadcast channel.

7. A broadcast receiving method comprising:
acquiring, via a network, standard time information, time correction information obtained by delaying a broadcast signal of a specific broadcast channel by IP retransmission, and stream information;
obtaining a broadcast time of the specific broadcast channel, based on the standard time information and the time correction information; and
storing reservation information on a program of the specific broadcast channel, and then, in response to the broadcast time, carrying out reserved image recording of stream information responsive to the reservation information.

8. The broadcast receiving method according to claim 7, wherein the time correction information also includes an internal error caused by an internal processing operation of a broadcast receiving apparatus.
